(19) United States
(12) Patent Application Publication
(10) Pub. No.: US 2012/0168269 A1
(43) Pub. Date: Jul. 5, 2012

(54) Damper

(75) Inventor: Sigmund Braun, Kusterdingen (DE)

(73) Assignee: Robert Bosch GmbH, Stuttgart (DE)

(21) Appl. No.: 13/380,817

(22) PCT Filed: Jun. 25, 2010
(86) PCT No.: PCT/EP2010/059095

§ 371 Date: Mar. 20, 2012

(30) Foreign Application Priority Data
Jun. 29, 2009 (DE) 10 2009 027 271.2

(51) Int. Cl. F16F 9/34

(52) U.S. Cl. 188/322.15

(57) ABSTRACT

A damper includes a damper cylinder, a piston unit comprising a piston ram guided via a piston rod in the damper cylinder, a flow device arranged within the damper cylinder for the passage of a damper fluid flow, which device includes at least one control gap for setting a characteristic damping curve, and an adjustment device arranged within the damper cylinder for controlling the control gap, which device includes at least two spring elements and at least one guide body. The adjustment device includes at least one valve piston that together with the guide body forms the at least one control gap.

### PRIOR ART

The invention proceeds from a damper according to the generic type of independent patent claim 1.

Laid open specification DE 10 2007 025 966 A1 describes a damper for a vehicle. The damper which is described comprises a damper cylinder which is filled with a damper fluid and in which a piston plunger is guided via a piston rod. In the case of an axial movement of the piston rod and therefore of the piston plunger with respect to the damper cylinder, the damper fluid has to flow through a throughflow device which is arranged within the damper cylinder and has control gaps for defining a damping characteristic curve characteristic. In order to regulate the damper fluid stream, the damper has an adjusting device which is arranged within the damper cylinder and has two spring elements and at least one intermediate plate which is arranged between the spring elements. A control gap is formed in each case between a movable spring element and a stationary control edge in the damper cylinder. As a result of the resistance which is generated against the damper fluid within the throughflow device, pressure differences are produced which produce damping forces via active faces. In order that the damper can perform damping work in two directions and therefore damps both during what is known as the rebound and during what is known as the compression, the throughflow device has a compression stage which acts in a first throughflow direction and a rebound stage which acts in a second throughflow direction. In order to regulate the damper fluid stream in the throughflow device and/or in order to regulate the control gap, slide units are provided which load the spring elements in order to set a spring characteristic.

### DISCLOSURE OF THE INVENTION

In contrast with this, the damper according to the invention having the features of independent patent claim 1 has the advantage that the adjusting device has at least one valve piston which, together with the guide body, forms the at least one control gap. As a result, it becomes possible in an advantageous way to provide an inexpensive solution suitable for mass production for producing the control gap, by the valve piston according to the invention of the adjusting device assuming the control gap function. In comparison with the current prior art, simple and inexpensive components can be used on account of the production according to the invention of the control gap. In particular, the geometries of the corresponding components necessary for the production of the control gap can be set in a vehicle-relevant manner by simple changes to the machining of the components. This results in a particularly advantageous way in relief of the spring unit, since the latter no longer has to assume any control gap functions, but rather only generates a force which can be set in a variable manner and loads the valve piston. The requirements made of the production tolerances can therefore be reduced considerably in the spring unit. Overall, the robustness with respect to disruptions during operation can be increased considerably. As a result, disruption-free functioning and substantially improved reproducibility of the damper characteristic curves are ensured in an advantageous way. In particular, as a result of the embodiments according to the invention, high damping forces can already be generated at low piston speeds.

Advantageous improvements of the damper which is specified in independent patent claim 1 are possible as a result of the measures and developments described in the dependent claims.

The at least one valve piston preferably has a sealing region and a guide region. Starting from a blank which is configured, for example, as a cold peened part, the valve piston can preferably be produced by the locating fit for the valve seats being produced by machining with the removal of material and a variable control edge height being possible as a function of the machining.

In one refinement of the damper according to the invention, the sealing region of the valve piston is of plate-shaped configuration. In an advantageous way, as a result, a reliable seal between the valve piston and the guide body is made possible in a structurally simple way without additional component outlay, which seal prevents throughflow of the damper fluid as far as possible.

In a further refinement of the damper according to the invention, the guide region of the valve piston is of web-shaped configuration. In an advantageous way, as a result, guidance of the damper fluid is possible in a structurally simple way without additional component outlay.

In one refinement of the damper according to the invention, the at least one valve piston can be received in a cutout of the guide body. This refinement allows expensive requirements of the position and assembly tolerances in the damper production to be reduced considerably and, as a result, both the production costs of the components and the assembly costs of the damper to be reduced. In particular, this results in process reliability and robustness with respect to disruptions during operation of the damper. Starting from a blank which is configured, for example, as a punched part, the guide body can preferably be produced by the locating fit for the valve seats being produced by machining with the removal of material.

In a further refinement of the damper according to the invention, at least the sealing region of the at least one valve piston and the corresponding cutout of the guide body have round cross sections. In an advantageous way, the round cross sections make a precision of the sealing faces and of the valve seats possible as a result of simple machining of the components. In particular, this refinement makes a high rising gradient of the damper characteristic curves possible.

In the damper according to the invention, the cutout of the guide body has a circumferential shoulder, against which a circumferential collar of the valve piston can bear. In an advantageous way, simple geometries result in an effective seal between the valve piston and the guide body. A further advantage comprises the simple production of the two components and the low space requirement of the valve piston, which results in a considerable cost saving.

In one refinement of the damper according to the invention, the valve piston which is received in the cutout is flush with its sealing region to a surface of the guide body. In an advantageous way, the loading of the valve piston by the spring element is therefore ensured by the spring element being in constant contact with the valve piston.

In the damper according to the invention, at least one spring element can bear flatly against the surface of the guide body and the sealing region of the flushly received valve piston. In an advantageous way, this refinement makes loading of the valve piston possible, which loading is reliable and can be set in a targeted manner.

In one refinement of the damper according to the invention, the at least one spring element can be loaded by at least one slide unit in order to set a spring characteristic. The spring element and the slide unit are preferably configured in such a way that low actuating forces are sufficient to set the spring characteristic and/or to shift the slide unit, with the result that, for example, rotary magnets, stepping motors, etc. can be used as rotational drive units.

In a further refinement of the damper according to the invention, the damper has at least one first valve piston which is arranged in a compression stage of the throughflow device, which compression stage acts in a first throughflow direction, and at least one second valve piston which is arranged in a rebound stage of the throughflow device, which rebound stage acts in a second throughflow direction. In an advantageous way, targeted setting of the damper behavior is possible as a result. In particular, the damper according to the invention makes direct control of the damper fluid stream possible, which control takes place practically without lag and/or transient states.

One exemplary embodiment of the invention is shown in the drawings and will be explained in greater detail in the following description.

### BRIEF DESCRIPTION OF THE DRAWINGS

FIG. 1 shows a diagrammatic perspective illustration of one exemplary embodiment of a damper according to the invention having a damper cylinder and a piston unit which comprises a piston rod and a piston plunger.

FIG. 2 shows a perspective cross section through a piston plunger having an adjusting device according to the invention which comprises spring elements, a guide body which is arranged between the spring elements and has a valve piston, and two slide units.

FIG. 3 shows a perspective illustration of the adjusting device according to the invention having two valve pistons which are arranged in the guide body, and a spring element with a slide unit.

FIG. 4 shows a perspective illustration of the adjusting device according to the invention having two valve pistons which are arranged in the guide body.

FIG. 5 shows a perspective illustration of the guide body having two cutouts for the valve pistons.

FIG. 6 shows a perspective illustration of the valve piston.

### EMBODIMENTS OF THE INVENTION

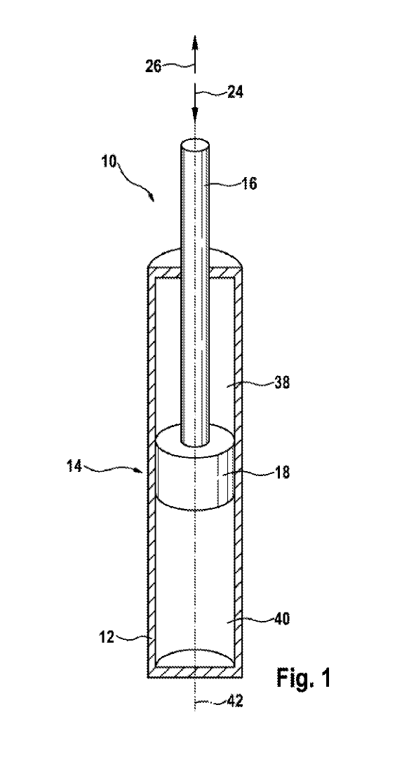

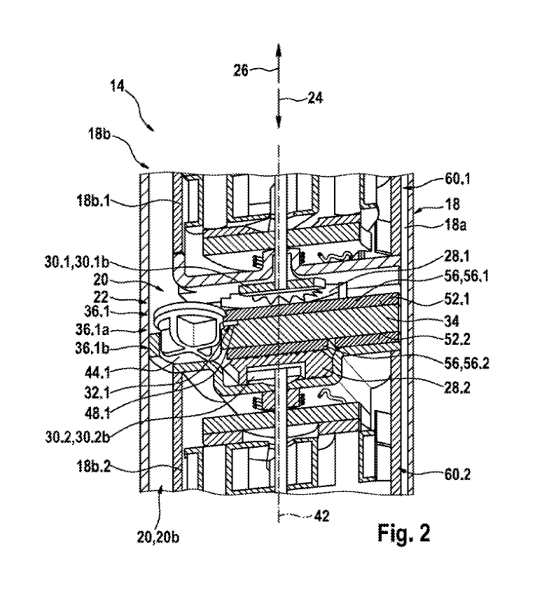

As can be seen from FIG. 1, a damper 10 according to the invention which is preferably configured as a shock absorber of a vehicle comprises a damper cylinder 12 which is filled with a damper fluid and in which a piston unit 14 is arranged movably which comprises a piston rod 16 and a piston plunger 18, the piston plunger 18 being guided in the damper cylinder 12 via the piston rod 16. The piston plunger 18 divides the damper cylinder 12 into an upper damper chamber 38 and into a lower damper chamber 40. In the case of an axial movement of the piston rod 16 and therefore of the piston plunger 18 with respect to the damper cylinder 12, which movement preferably extends in the direction of a vertical axis 42 of the damper 10, the damper fluid has to flow through a throughflow device 20 (shown in FIG. 2) which is arranged within the damper cylinder 12 and has at least one control gap 32.1, 32.2 in order to define a damping characteristic curve characteristic. The throughflow device 20 preferably has at least two throughflow channels, only one throughflow channel 20b being visible in FIG. 2. The further throughflow channel which is not visible is arranged offset by an angle of preferably approximately 90° with respect to the throughflow channel 20b.

As can be seen from FIG. 2, the piston plunger 18 is configured as a compact unit. The piston plunger 18 comprises a plunger tube 18a which is configured, for example, as a thin-walled steel tube, and a drive housing unit 18b which is arranged within the plunger tube 18a and accommodates a drive unit 60.1, 60.2 which preferably has two drives. In the present exemplary embodiment, the drive housing unit 18b comprises two drive housings 18b.1 and 18b.2 which in each case accommodate a drive 60.1, 60.2, it being possible for the drives 60.1, 60.2 to be configured, for example, as a magnetic rotary drive. The geometries of the plunger tube 18a and the drive housing unit 18b, 18b.1 and 18b.2 together form the two throughflow channels of the throughflow device 20, of which only the throughflow channel 20b is visible and which are preferably of substantially identical configuration. This means that the throughflow channels are arranged substantially between the drive housing unit 18b, 18b.1 and 18b.2 and the inner wall of the plunger tube 18a.

The throughflow device 20 comprises at least one compression stage which acts in a first throughflow direction 26 and/or at least one rebound stage which acts in a second throughflow direction 24. In the present exemplary embodiment, the rebound stage acts in the throughflow channel which is not visible and is offset by an angle of preferably approximately 90° with respect to the throughflow channel 20b, and the compression stage acts in the throughflow channel 20b which is shown. The throughflow direction 24, 26 of the two throughflow channels is opposed, the respective direction not changing within a throughflow channel 20b. The throughflow device 20 preferably forms a closed circuit.

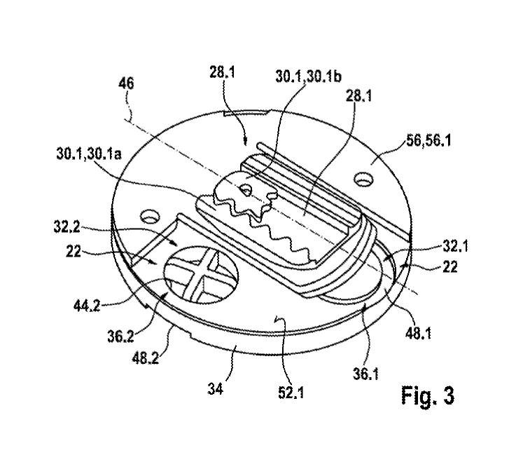

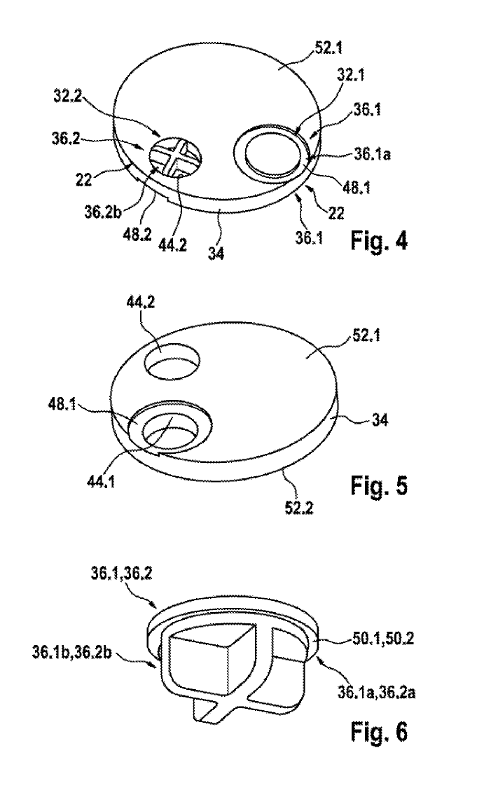

As can be seen from FIGS. 2 to 6, an adjusting device for regulating the control gap 32.1, 32.2 in the throughflow device 20 is arranged within the damper cylinder 12. The adjusting device 22 has a spring unit 56 which preferably comprises two spring elements 56.1, 56.2, and a guide body 34 which is arranged between the spring elements 56.1, 56.2 and is configured here as an intermediate plate. The spring elements 56.1, 56.2 are preferably configured as spring assemblies. In order to set the spring characteristics, the spring elements 56.1, 56.2 can be loaded by in each case one slide unit 28.1, 28.2. To this end, the slide units 28.1, 28.2 which can be displaced in each case on the spring elements 56.1, 56.2 and comprise means 30.1, 30.2 for converting movements are provided above the spring elements 56.1, 56.2. The slide units 28.1, 28.2 in each case adjoin the drive housings 18b.1, 18b.2 of the drive housing unit 18b. In the present exemplary embodiment, the slide units 28.1, 28.2 adjoin the drive housings 18b.1, 18b.2 directly. In the present exemplary embodiment, the slide unit 28.1, 28.2 is configured as a displacing element which can be displaced on the spring unit 56, 56.1, 56.2 along a longitudinal axis 46. The slide unit 28.1, 28.2 is preferably configured as a variable supporting bearing point.

In the present exemplary embodiment, the means 30.1, 30.2 for converting movements are configured as a rack segment 30.1a, 30.2a, into which a gearwheel segment 30.1b, 30.2b engages which is moved by the corresponding drive 60.1, 60.2 in order to change the position of the slide unit 28.1, 28.2. In the present exemplary embodiment, the means 30.1, 30.2, 30.1a, 30.2a, 30.1b, 30.2b therefore convert a rotational movement of the drive unit 60.1, 60.2 into a translational movement of the slide unit 28.1, 28.2 in the direction of the longitudinal axis 46, by the drive unit 60.1, 60.2 loading the gearwheel segment 30.1b, 30.2b with a rotational movement, which gearwheel segment 30.1b, 30.2b engages into the rack segment 30.1a, 30.2a and sets the latter into a translational movement. That is to say, for displacement, the slide unit 28.1, 28.2 has the rack segment 30.1a, 30.2a, into which the gearwheel segment 30.1b, 30.2b engages which is rotated by the corresponding drive unit 60.1, 60.2 in order to change the position of the slide unit 28.1, 28.2. In the present exemplary embodiment, the rack segment 30.1a, 30.2a is preferably configured in one piece with the slide unit 28.1, 28.2. In order to set the damper fluid stream in the throughflow device 20 and/or in order to regulate the control gap 32.1, 32.2, the adjusting device 22 is activated by in each case one slide unit 28.1, 28.2 of the adjusting device 22 being displaced.

In order to make inexpensive production of a damper possible which is suitable for mass manufacturing, according to the invention the adjusting device 22 has at least one valve piston 36.1, 36.2 which forms the at least one control gap 32.1, 32.2 with the guide body 34. In the present exemplary embodiment, the adjusting device 22 comprises a first valve piston 36.1 which is arranged in the compression stage of the throughflow device 20, which compression stage acts in the first throughflow direction 26, and a second valve piston 36.2 which is arranged in the rebound stage of the throughflow device 20, which rebound stage acts in the second throughflow direction 24. In order to form the control gap 32.1, 32.2, the respective valve piston 36.1, 36.2 can be received substantially in the direction of the vertical axis 42 in a cutout 44.1, 44.2 of the guide body 34.

The valve piston 36.1, 36.2 has a sealing region 36.1a, 36.2a and a guide region 36.1b, 36.2b, the sealing region 36.1a, 36.2a preferably being of plate-shaped configuration and the guide region 36.1b, 36.2b preferably being of web-shaped configuration. As an alternative to this, however, all embodiments of the valve piston 36.1, 36.2 are conceivable which appear appropriate to a person skilled in the art. In the present exemplary embodiment, the sealing region 36.1a, 36.2a of the valve piston 36.1, 36.2 and the corresponding cutout 44.1, 44.2 of the guide body 34 preferably have round cross sections, all other cross-sectional shapes being conceivable which appear appropriate to a person skilled in the art.

The cutout 44.1, 44.2 of the guide body 34 has a circumferential shoulder 48.1, 48.2, against which a circumferential collar 50.1, 50.2 of the valve piston 36.1, 36.2 can bear. The valve piston 36.1, 36.2 which is received in the cutout 44.1, 44.2 is flush with its sealing region 36.1a, 36.2a to a surface 52.1, 52.2 of the guide body 34. In the assembled state of the damper 10, the spring elements 56.1, 56.2 of the spring unit 56 bear flatly against the surface 52.1, 52.2 of the guide body 34 and the sealing region 36.1a, 36.2a of the flushly received valve piston 36.1, 36.2.

In operation and/or during a loading of the damper 10, a damper fluid stream flows in the throughflow device 20 as a result of the movement of the piston unit 14, which movement is directed in the direction of the vertical axis 42 of the damper 10 or of the damper cylinder 12, the damper fluid stream also being guided in each case by one of the two control gaps 32.1, 32.2. The collar 50.1 or 50.2 of the valve piston 36.1 or 36.2 raises up from the shoulder 48.1 or 48.2 as a function of the spring rate of the spring element 56.1, 56.2, which spring rate is set via the slide unit 28.1 or 28.2, and a defined control gap 32.1 or 32.2 results. This means that the valve piston 36.1 or 36.2 is loaded by the damper fluid stream which acts in a throughflow direction 24 or 26 and by the spring element 56.1, 56.2 which acts in the opposite direction, with the result that the control gap 32.1, 32.2 which is produced between the valve piston 36.1 or 36.2 and the guide body 34 is formed as a function of these two variables.

1. A damper, comprising:
a damper cylinder,
a piston unit having a piston rod and a piston plunger which is guided in the damper cylinder,
a throughflow device which is arranged within the damper cylinder for throughflow of a damper fluid stream, which throughflow device has at least one control gap for defining a damping characteristic curve characteristic, and
an adjusting device which is arranged within the damper cylinder for regulating the control gap, which adjusting device has at least one spring element and at least one guide body,
wherein the adjusting device has at least one valve piston which, together with the guide body, forms the at least one control gap.

2. The damper as claimed in claim 1, wherein the at least one valve piston has a sealing region and a guide region.

3. The damper as claimed in claim 2, wherein the sealing region is of plate-shaped configuration.

4. The damper as claimed in claim 2, wherein the guide region is of web-shaped configuration.

5. The damper as claimed in claim 1, wherein the at least one valve piston is configured to be received in a cutout of the guide body.

6. The damper as claimed in claim 5, wherein at least the sealing region of the at least one valve piston and the corresponding cutout of the guide body have round cross sections.

7. The damper as claimed in claim 5, wherein the cutout has a circumferential shoulder against which a circumferential collar of the valve piston is configured to bear.

8. The damper as claimed in claim 5, wherein the valve piston is received in the cutout and is flush with its sealing region to a surface of the guide body.

9. The damper as claimed in claim 1, wherein the at least one spring element is configured to bear flatly against the surface of the guide body and the sealing region of the flushly received valve piston.

10. The damper as claimed in claim 1, wherein the at least one spring element is configured to be loaded by at least one slide unit in order to set a spring characteristic.

11. The damper as claimed in claim 1, wherein the at least one valve piston includes at least one first valve piston which is arranged in a compression stage of the throughflow device, which compression stage acts in a first throughflow direction and at least one second valve piston which is arranged in a rebound stage of the throughflow device, which rebound stage acts in a second throughflow direction.
